(19) United States
(12) Patent Application Publication
(10) Pub. No.: US 2023/0365839 A1
(43) Pub. Date: Nov. 16, 2023

(54) ADHESIVE COMPOSITION FOR FOLDABLE DISPLAY AND ADHESIVE FILM FOR FOLDABLE DISPLAY COMPRISING CURED PRODUCT THEREOF

(71) Applicant: LG CHEM, LTD., Seoul (KR)

(72) Inventors: Hee SONG, Daejeon (KR); Hyun Cheol KIM, Daejeon (KR)

(73) Assignee: LG CHEM, LTD., Seoul (KR)

(21) Appl. No.: 18/044,947

(22) PCT Filed: Aug. 20, 2021
(86) PCT No.: PCT/KR2021/011117

§ 371 Date: Mar. 10, 2023

(30) Foreign Application Priority Data
Sep. 11, 2020 (KR) 10-2020-0116499

(51) Int. Cl. C09J 7/38; C09J 11/06; C09J 7/10

(52) U.S. Cl. CPC C09J 7/385; C09J 7/10; C09J 11/06; C09J 2203/326; C09J 2301/414; C09J 2433/00

(57) ABSTRACT

An adhesive composition for a foldable display containing a (meth)acrylate-based polymer and an adhesive film comprising a cured product of the adhesive composition, which provide excellent folding properties even under sub-zero temperature conditions, and thus may be easily applied to a foldable display, are provided.

### BACKGROUND

### 1. Technical Field

This application is a 35 U.S.C. 371 National Phase Entry Application from PCT/KR2021/011117 filed on Aug. 20, 2021, which claims the benefit of the filing date of Korean Patent Application No. 10-2020-0116499, filed with the Korean Intellectual Property Office on Sep. 11, 2020, the entire contents of which are incorporated herein by reference.

The present invention relates to an adhesive composition for a foldable display and an adhesive film for a foldable display including an adhesive layer including a cured product thereof.

### 2. Background of the Invention

In recent years, with the development of display-related technologies, display devices that can be deformed at the stage of use, such as folding, winding in a roll shape, or stretching like a rubber band, have been studied and developed. These displays may be deformed into various shapes, and thus may satisfy demands for both a larger display at the stage of use and a smaller display for carrying.

A deformable display device may be deformed into various shapes in accordance with user demands or depending on the needs of the situation in which the display device is used as well as deformed into a predetermined shape. Therefore, it is necessary to recognize the deformed shape of the display and to control the display device in accordance with the recognized shape.

Meanwhile, the deformable display device has a problem in that each component of the display device may be damaged by deformation, and thus each component of such a display device needs to satisfy folding reliability and stability. In particular, an adhesive film for fixing each component of the display device needs to be sufficiently deformable to relieve stress that is applied to each component when the display is deformed. In addition, in recent years, there has been a demand for an adhesive film having physical properties capable of realizing folding characteristics even when the adhesive film is used under sub-zero temperature conditions.

Accordingly, there is a need for an adhesive film having physical properties that may be easily applied to a foldable display.

### BRIEF SUMMARY OF INVENTION

An object of the present invention is to provide an adhesive film, which has excellent folding properties even under sub-zero temperature conditions, and thus may be easily applied to a foldable display, and an adhesive composition that may provide the same.

However, the objects to be achieved by the present invention are not limited to the above-mentioned object, and other objects not mentioned herein will be clearly understood by those skilled in the art from the following description.

One embodiment of the present invention provides an adhesive composition for a foldable display containing a (meth)acrylate-based polymer which is a reaction product of a monomer mixture containing: a first monomer including at least one of a first acrylate-based monomer containing an alkyl group having 12 to 14 carbon atoms, and a first methacrylate-based monomer containing an alkyl group having 14 to 16 carbon atoms; a second monomer including at least one of a second acrylate-based monomer containing an alkyl group having 3 to 10 carbon atoms, and a second methacrylate-based monomer containing an alkyl group having 8 to 12 carbon atoms; and a (meth)acrylate-based monomer containing a polar functional group.

Another embodiment of the present invention provides an adhesive film for a foldable display including an adhesive layer including a cured product of the adhesive composition for a foldable display.

The adhesive composition for a foldable display according to one embodiment of the present invention may provide an adhesive layer having excellent folding properties under room temperature and sub-zero temperature conditions.

In addition, the adhesive film for a foldable display according to one embodiment of the present invention may have excellent folding reliability under room temperature and sub-zero temperature conditions.

Effects of the present invention are not limited to the above-described effects, and effects not mentioned herein will be clearly understood by those skilled in the art from the present specification and the accompanying drawings.

### BRIEF DESCRIPTION OF THE DRAWINGS

FIG. 1 is a schematic view showing a sample for folding evaluation.

FIG. 2 is a schematic view showing a folding test.

### DETAILED DESCRIPTION OF INVENTION

Throughout the present specification, it is to be understood that when any part is referred to as “including” any component, it does not exclude other components, but may further include other components, unless otherwise specified.

Throughout the present specification, when any member is referred to as being “on” another member, it not only refers to a case where any member is in contact with another member, but also a case where a third member exists between the two members.

Throughout the present specification, the unit “parts by weight” may refer to the ratio of weight between components.

Throughout this specification, the term “(meth)acrylate” is meant to include acrylate and methacrylate.

Throughout the present specification, terms including ordinal numbers such as “first” and “second” are used for the purpose of distinguishing one component from other components, and the components are not limited by the ordinal numbers. For example, a first component may be termed a second component without departing the scope of the present disclosure, and similarly, a second component may also be termed a first component.

Throughout the present specification, the “weight-average molecular weight” and “number-average molecular weight” of any compound may be calculated using the molecular weight and molecular weight distribution of the compound. Specifically, the molecular weight and molecular weight distribution of the compound may be obtained by: placing tetrahydrofuran (THF) and the compound in a 1-ml glass vial to prepare a test sample in which the concentration of the compound is 1 wt%; filtering a standard sample (polystyrene) and the test sample through a filter (pore size: 0.45 µm); injecting each of the sample filtrates into a GPC injector; and comparing the elution time of the test sample with a calibration curve of the standard sample. At this time, Infinity II 1260 (Agilent Technologies, Inc.) may be used as a measurement instrument, and the flow rate and the column temperature may be set at 1.00 mL/min and 40.0° C., respectively.

Throughout this specification, the storage modulus of the adhesive layer may be measured using an Advanced Rheometric Expansion System (ARES)-G2 rheometer (TA Instruments).

Hereinafter, the present specification will be described in more detail.

One embodiment of the present invention provides an adhesive composition for a foldable display containing a (meth)acrylate-based polymer which is a reaction product of a monomer mixture containing: a first monomer including at least one of a first acrylate-based monomer containing an alkyl group having 12 to 14 carbon atoms, and a first methacrylate-based monomer containing an alkyl group having 14 to 16 carbon atoms; a second monomer including at least one of a second acrylate-based monomer containing an alkyl group having 3 to 10 carbon atoms, and a second methacrylate-based monomer containing an alkyl group having 8 to 12 carbon atoms; and a (meth)acrylate-based monomer containing a polar functional group.

The adhesive composition for a foldable display according to one embodiment of the present invention may provide an adhesive layer having excellent folding properties under room temperature and sub-zero temperature conditions.

According to one embodiment of the present invention, the adhesive composition for a foldable display may provide an adhesive layer having excellent folding reliability even at low temperatures by containing the (meth)acrylate-based polymer produced by reaction of the monomer mixture containing the first monomer, the second monomer and the (meth)acrylate-based monomer containing a polar functional group.

According to one embodiment of the present invention, the first monomer may include at least one of a first acrylate-based monomer containing an alkyl group having 12 to 14 carbon atoms, and a first methacrylate-based monomer containing an alkyl group having 14 to 16 carbon atoms.

Specifically, the first acrylate-based monomer may contain a linear or branched alkyl group having 12 to 14 carbon atoms. For example, the first acrylate-based monomer may include at least one of n-dodecyl acrylate (lauryl acrylate), isododecyl acrylate, n-tridecyl acrylate, isotridecyl acrylate, n-tetradecyl acrylate, and isotetradecyl acrylate.

In addition, the first methacrylate-based monomer may contain a linear or branched alkyl group having 14 to 16 carbon atoms. For example, the first methacrylate-based monomer may include at least one of n-tetradecyl methacrylate, isotetradecyl methacrylate, n-pentadecyl methacrylate, isopentadecyl methacrylate, n-hexadecyl methacrylate, and isohexadecyl methacrylate.

As at least one of the first acrylate-based monomer and the first methacrylate-based monomer is used as the first monomer, it is possible to effectively improve the low-temperature (e.g., -20° C.) folding reliability of the cured product of the adhesive composition for a foldable display.

According to one embodiment of the present invention, the content of the first monomer may be 20 parts by weight to 60 parts by weight based on 100 parts by weight of the monomer mixture. Specifically, the content of the first monomer may be 25 parts by weight to 55 parts by weight, 30 parts by weight to 50 parts by weight, 35 parts by weight to 45 parts by weight, 20 parts by weight to 50 parts by weight, 22.5 parts by weight to 47.5 parts by weight, 25 parts by weight to 45 parts by weight, 27.5 parts by weight to 42.5 parts by weight, 30 parts by weight to 40 parts by weight, 32.5 parts by weight to 47.5 parts by weight, 35 parts by weight to 45 parts by weight, 37.5 parts by weight to 42.5 parts by weight, 35 parts by weight to 60 parts by weight, 38 parts by weight to 57.5 parts by weight, 40 parts by weight to 55 parts by weight, 43 parts by weight to 52.5 parts by weight, or 45 parts by weight to 50 parts by weight, based on 100 parts by weight of the monomer mixture.

As the content of the first monomer in the monomer mixture is controlled within the above-described range, it is possible to effectively reduce the low-temperature storage modulus of the cured product of the adhesive composition for a foldable display. In addition, when the content of the first monomer is within the above-described range, it is possible to suppress the crystallinity of the cured product, thereby improving the folding properties of the adhesive layer including the cured product.

According to one embodiment of the present invention, the second monomer may include at least one of a second acrylate-based monomer containing an alkyl group having 3 to 10 carbon atoms, and a second methacrylate-based monomer containing an alkyl group having 8 to 12 carbon atoms.

Specifically, the second acrylate-based monomer may contain a linear or branched alkyl group having 3 to 10 carbon atoms. For example, the second acrylate-based monomer may include at least one of n-propyl acrylate, isopropyl acrylate, n-butyl acrylate, isobutyl acrylate, n-pentyl acrylate, isopentyl acrylate, n-hexyl acrylate, isohexyl acrylate, n-heptyl acrylate, isoheptyl acrylate, n-octyl acrylate, isooctyl acrylate, ethylhexyl acrylate, n-nonyl acrylate, isononyl acrylate, n-decyl acrylate, and isodecyl acrylate.

In addition, the second methacrylate-based monomer may contain a linear or branched alkyl group having 8 to 12 carbon atoms. For example, the second methacrylate-based monomer may include at least one of n-octyl methacrylate, isooctyl methacrylate, ethylhexyl methacrylate, n-nonyl methacrylate, isononyl methacrylate, n-decyl methacrylate, isodecyl methacrylate, n-undecyl methacrylate, isoundecyl methacrylate, n-dodecyl methacrylate, and isododecyl methacrylate.

As at least one of the second acrylate-based monomer and the second methacrylate-based monomer is used as the second monomer, it is possible to effectively improve the low-temperature (e.g., -20° C.) folding reliability of the cured product of the adhesive composition for a foldable display.

According to one embodiment of the present invention, the content of the second monomer may be 35 parts by weight to 80 parts by weight based on 100 parts by weight of the monomer mixture. Specifically, the content of the second monomer may be more than 35 parts by weight to less than 80 parts by weight, 36 parts by weight to 79 parts by weight, 40 parts by weight to 79 parts by weight, 45 parts by weight to 79 parts by weight, 50 parts by weight to 75 parts by weight, 55 parts by weight to 70 parts by weight, 60 parts by weight to 65 parts by weight, 35 parts by weight to 65 parts by weight, 37.5 parts by weight to 62.5 parts by weight, 40 parts by weight to 60 parts by weight, 42.5 parts by weight to 57.5 parts by weight, 45 parts by weight to 55 parts by weight, 47.5 parts by weight to 52.5 parts by weight, 50 parts by weight to 80 parts by weight, 52.5 parts by weight to 75 parts by weight, 55 parts by weight to 70 parts by weight, 57.5 parts by weight to 67.5 parts by weight, or 60 parts by weight to 65 parts by weight, based on 100 parts by weight of the monomer mixture.

As the content of the second monomer in the monomer mixture is controlled within the above-described range, it is possible to effectively reduce the low-temperature storage modulus of the cured product of the adhesive composition for a foldable display.

According to one embodiment of the present invention, the (meth)acrylate-based monomer containing a polar functional group may contain a carboxylic acid group. That is, the (meth)acrylate-based monomer may contain a carboxylic acid group as a polar functional group. As the (meth)acrylate-based monomer containing a carboxylic acid group is used, the (meth)acrylate-based polymer may be effectively cured by an epoxy-based crosslinking agent to be described later. In addition, as the (meth) acrylate-based monomer containing a carboxylic acid group is used, the adhesiveness of the cured product of the adhesive composition for a foldable display may be maintained, and thus the adhesive film for a foldable display may be prevented from being detached from a substrate film during folding.

The (meth)acrylate-based monomer containing a polar functional group may include, for example, at least one of (meth)acrylic acid, 2-(meth)acryloyloxyacetic acid, 3-(meth)acryloyloxypropyl acid, 4-(meth)acryloyloxybutyric acid, and a (meth)acrylic acid dimer.

According to one embodiment of the present invention, the content of the polar functional group-containing (meth)acrylate-based monomer may be 1 part by weight to 4 parts by weight based on 100 parts by weight of the monomer mixture. Specifically, the content of the polar functional group-containing (meth)acrylate-based monomer may be 1 part by weight to 3 parts by weight, 1 part by weight to 2 parts by weight, 2 parts by weight to 4 parts by weight, or 2 parts by weight to 3 parts by weight, based on 100 parts by weight of the monomer mixture. As the content of the polar functional group-containing (meth)acrylate-based monomer is controlled within the above-described range, it is possible to effectively improve the adhesive performance of the cured product of the adhesive composition for a foldable display.

According to one embodiment of the present invention, the weight ratio between the first monomer and the (meth)acrylate-based monomer containing a polar functional group may be 1:0.025 to 1:0.1. Specifically, the weight ratio between the first monomer and the polar functional group-containing (meth)acrylate-based monomer contained in the monomer mixture may be 1:0.03 to 1:0.08, 1:0.04 to 1:0.06, 1:0.025 to 1:0.07, 1:0.035 to 1:0.05, 1:0.05 to 1:0.1, or 1:0.08 to 1:0.1. When the weight ratio between the first monomer and the polar functional group-containing (meth)acrylate-based monomer contained in the monomer mixture is within the above-described range, it is possible to effectively reduce the low-temperature storage modulus of the cured product of the adhesive composition for a foldable display. In addition, it is possible to suppress the cured product from having crystallinity, thereby improving the folding properties of the adhesive layer including the cured product.

According to one embodiment of the present invention, the weight ratio between the first monomer and the second monomer may be 1:0.5 to 1:4. Specifically, the weight ratio between the first monomer and the second monomer contained in the monomer mixture may be 1:0.6 to 1:3.7, 1:0.7 to 1:3.5, 1:0.9 to 1:3, 1:1 to 1 :2.7, 1:1.5 to 1:2.5, 1:0.5 to 1:3, 1:0.8 to 1:2.5, 1:1 to 1:2, 1:1.5 to 1:4, 1:2 to 1:4, or 1:3 to 1:4. As the weight ratio between the first monomer and the second monomer contained in the monomer mixture is controlled within the above-described range, it is possible to effectively reduce the low-temperature storage modulus of the cured product of the adhesive composition for a foldable display. In addition, it is possible to suppress the cured product of the adhesive composition for a foldable display from having crystallinity, thereby effectively improving the folding properties of the adhesive layer including the cured product of the adhesive composition for a foldable display.

According to one embodiment of the present invention, the weight ratio between the polar functional group-containing (meth)acrylate-based monomer and the second monomer may be 1:10 to 1:85. Specifically, the weight ratio between the polar functional group-containing (meth)acrylate-based monomer and the second monomer contained in the monomer mixture may be 1:15 to 1:80, 1:20 to 1:75, 1:25 to 1:70, 1:30 to 1:65, 1:30 to 1:50, 1:10 to 1:65, 1:15 to 1:60, 1:20 to 1:55, 1:25 to 1:50, 1:30 to 1:45, 1:30 to 1:85, 1:35 to 1:80, 1:40 to 1:75, 1:45 to 1:70, or 1:50 to 1:65. When the weight ratio between the polar functional group-containing (meth)acrylate-based monomer and the second monomer contained in the monomer mixture is within the above-described range, it is possible to effectively reduce the low-temperature storage modulus of the cured product of the adhesive composition for a foldable display, and to effectively improve the adhesive performance of the cured product of the adhesive composition for a foldable display.

According to one embodiment of the present invention, the (meth)acrylate-based polymer may be produced through thermal polymerization. Specifically, the (meth)acrylate-based polymer may be produced by adding a thermal initiator to the monomer mixture and performing thermal polymerization.

According to one embodiment of the present invention, the (meth) acrylate-based polymer may have a weight-average molecular weight of 1,500,000 to 2,500,000 g/mol. Specifically, the (meth) acrylate-based polymer may have a weight-average molecular weight of 1,500,000 g/mol to 2,500,000 g/mol, 1,650,000 g/mol to 2,300,000 g/mol, 1,800,000 g/mol to 2,200,000 g/mol, 1,500,000 g/mol to 2,000,000 g/mol, 1,700,000 g/mol to 2,000,000 g/mol, 1,850,000 g/mol to 2,000,000 g/mol, 2,000,000 g/mol to 2,500,000 g/mol, or 2,100,000 g/mol to 2,400,000 g/mol. When the weight-average molecular weight of the (meth)acrylate-based polymer is within the above range, the cured product of the adhesive composition for a foldable display may have excellent folding reliability and adhesiveness. In addition, when the weight-average molecular weight of the (meth)acrylate-based polymer is controlled within the above-described range, it is possible to effectively reduce the low-temperature storage modulus of the cured product of the adhesive composition for foldable display while maintaining the storage modulus of the cured product thereof at room temperature.

According to one embodiment of the present invention, the adhesive composition for a foldable display may further contain an epoxy-based crosslinking agent. As the epoxy-based crosslinking agent, any epoxy-based crosslinking agent used in the art may be used without limitation. Specifically, a polyfunctional epoxy compound may be used as the epoxy-based crosslinking agent, and the polyfunctional epoxy compound may include at least one of a diphenylmethane skeleton, a dinaphthalene skeleton, a triazine skeleton, and a biphenyl skeleton.

In addition, the epoxy-based crosslinking agent may include at least one of ethylene glycol diglycidyl ether, triglycidyl ether, trimethylolpropane triglycidyl ether, N,N,N′,N′-tetraglycidyl ethylenediamine, and glycerin diglycidyl ether, but the type of the epoxy-based crosslinking agent is not limited thereto. For example, BXX-5240 may be used as the epoxy-based crosslinking agent.

According to one embodiment of the present invention, the content of the epoxy-based crosslinking agent may be 0.01 parts by weight to 0.1 parts by weight based on 100 parts by weight of the (meth)acrylate-based polymer. Specifically, the content of the epoxy-based crosslinking agent may be 0.01 parts by weight to 0.07 parts by weight, 0.01 parts by weight to 0.05 parts by weight, or 0.01 parts by weight to 0.03 parts by weight, based on 100 parts by weight of the (meth)acrylate-based polymer. As the content of the epoxy-based crosslinking agent is controlled within the above-described range, it is possible to effectively perform the curing reaction of the (meth)acrylate-based polymer contained in the adhesive composition for a foldable display.

According to one embodiment of the present invention, the adhesive composition for a foldable display may further contain a solvent. As the solvent, any solvent used in the art may be used without limitation. For example, the solvent may include at least one of methyl ethyl ketone, ethyl acetate, toluene, xylene, benzene, cyclohexane, and cycloheptane, but the type of the solvent is not limited thereto.

According to one embodiment of the present invention, the adhesive composition for a foldable display may further contain an additive. For example, the additive may include at least one of a release control agent, an additional crosslinking agent, an antistatic agent, a tackifying resin, a curing agent, a UV stabilizer, an antioxidant, a colorant, a reinforcing agent, a filler, an antifoaming agent, and a surfactant, but the type of additive is not limited thereto.

According to one embodiment of the present invention, the solid content of the adhesive composition for a foldable display may be 10 wt% to 30 wt%. The term “solid content” may mean a component excluding the solvent contained in the adhesive composition for a foldable display. For example, the solid content may include the (meth)acrylate-based polymer and the epoxy-based crosslinking agent contained in the adhesive composition for a foldable display. The adhesive composition for a foldable display, which satisfies the above-described solid content, may have an appropriate viscosity, and thus may have excellent coating properties.

According to one embodiment of the present invention, the viscosity of the adhesive composition for a foldable display may be 500 cp to 2,500 cp. Specifically, the adhesive composition for a foldable display may have a viscosity of 500 cp to 2,500 cp, 700 cp to 2,300 cp, or 850 cp to 2,200 cp at 25° C. The adhesive composition for a foldable display having a viscosity within the above-described range may have excellent coating properties.

Another embodiment of the present invention provides an adhesive film for a foldable display including an adhesive layer including a cured product of the adhesive composition for a foldable display.

The adhesive film for a foldable display according to one embodiment of the present invention may have excellent folding reliability under room temperature and sub-zero temperature conditions.

According to one embodiment of the present invention, the adhesive film for a foldable display may include a release film and an adhesive layer including a cured product of the adhesive composition for a foldable display provided on the release film. As the release film, a release film used in the art may be selected and used without limitation. For example, as the release film, a polyester film release-treated with silicone may be used.

According to one embodiment of the present invention, the adhesive layer may include a thermally cured product of the adhesive composition for a foldable display. For example, the adhesive layer may be formed by applying the adhesive composition for a foldable display onto the release film and thermally curing the applied adhesive composition at a temperature of 100° C. to 150° C. for 1 minute to 5 minutes.

According to one embodiment of the present invention, the thickness of the adhesive layer may be 10 µm to 100 µm. Specifically, the thickness of the adhesive layer may be 15 µm to 80 µm, 20 µm to 65 µm, or 25 µm to 50 µm. When the thickness of the adhesive layer is within the above-described range, the adhesive layer may exhibit excellent adhesiveness and folding properties when applied to a foldable display.

According to one embodiment of the present invention, the adhesive layer may have a storage modulus of 100,000 Pa or lower as measured at -20° C. Specifically, the adhesive layer may have a storage modulus of 30,000 Pa to 100,000 Pa as measured at a temperature of -20° C. and a frequency of 1 Hz. More specifically, the storage modulus of the adhesive layer, measured at a temperature of -20° C. and a frequency of 1 Hz, may be 35,000 Pa to 98,000 Pa, 40,000 Pa to 98,000 Pa, 43,000 Pa to 98,000 Pa, 45,000 Pa to 95,000 Pa, 50,000 Pa to 90,000 Pa, 55,000 Pa to 85,000 Pa, 60,000 Pa to 80,000 Pa, 65,000 Pa to 75,000 Pa, 30,000 Pa to 65,000 Pa, 35,000 Pa to 63,000 Pa, 40,000 Pa to 61,000 Pa, 45,000 Pa to 59,000 Pa, 60,000 Pa to 100,000 Pa, 61,000 Pa to 98,000 Pa, 63,000 Pa to 95,000 Pa, 65,000 Pa to 90,000 Pa, or 70,000 Pa to 85,000 Pa. When the storage modulus of the adhesive layer at -20° C. is within the above range, the adhesive layer may exhibit excellent folding properties even at low temperatures.

According to one embodiment of the present invention, the adhesive layer may have a storage modulus of 10,000 Pa or higher as measured at 25° C. Specifically, the adhesive layer have a storage modulus of 10,000 Pa to 40,000 Pa as measured at a temperature of 25° C. and a frequency of 1 Hz. More specifically, the storage modulus of the adhesive layer, measured at a temperature of 25° C. and a frequency of 1 Hz, may be 10,000 Pa to 37,000 Pa, 10,000 Pa to 36,000 Pa, 15,000 Pa to 35,000 Pa, 20,000 Pa to 30,000 Pa, 10,000 Pa to 30,000 Pa, 12,000 Pa to 28,000 Pa, 15,000 Pa to 26,000 Pa, 17,000 Pa to 25,000 Pa, 20,000 Pa to 24,000 Pa, 20,000 Pa to 40,000 Pa, 20,000 Pa to 36,000 Pa, 22,000 Pa to 34,000 Pa, 24,000 Pa to 31,000 Pa, or 25,000 Pa to 28,000 Pa. The adhesive layer having a storage modulus at 25° C. that satisfies the above-described range may have excellent folding properties, and thus may effectively relieve stress applied to the components of the foldable display.

According to one embodiment of the present invention, the storage modulus of the adhesive layer at -20° C. and the storage modulus thereof at 25° C. may be measured using an ARES-G2 rheometer as described above.

Therefore, the adhesive layer according to one embodiment of the present invention may have excellent folding properties, and thus may be easily applied to a foldable display.

Hereinafter, the present invention will be described in detail with reference to examples.

### Example 1

### Production of (Meth)Acrylate-Based Polymer

Lauryl acrylate as a first monomer, 2-ethylhexyl acrylate as a second monomer, and acrylic acid as a (meth)acrylate-based monomer containing a polar functional group were prepared and mixed together to obtain a monomer mixture.

In this case, based on 100 parts by weight of the monomer mixture, the content of the first monomer was 20 parts by weight, the content of the second monomer was 79 parts by weight, and the content of the polar functional group-containing (meth)acrylate-based monomer was 1 part by weight.

To a 1-L reactor, in which nitrogen gas was refluxed and which was equipped with a cooling device for easy temperature control, the monomer mixture was added and then ethyl acetate (EAc) as a solvent was added. Next, the reactor was purged with nitrogen gas for about 1 hour to remove oxygen, and then the reactor temperature was maintained at 85° C. After the monomer mixture was homogenized, 5,000 ppm of benzoyl peroxide (BPO) as a reaction initiator was added thereto, and the monomer mixture was allowed to react for 6 hours, thus producing a (meth)acrylate-based polymer having a weight-average molecular weight of 1,850,000 g/mol. A (meth)acrylate-based polymer solution was prepared by diluting the (meth)acrylate-based polymer with ethyl acetate.

### Preparation of Adhesive Composition for Foldable Display

To the (meth)acrylate-based polymer solution prepared as described above, BXX-5240 as an epoxy-based crosslinking agent was added in an amount of 0.03 parts by weight based on 100 parts by weight of the (meth)acrylate-based polymer. The resulting mixture was diluted with methyl ethyl ketone and methyl isobutyl ketone and mixed using a mechanical stirrer for 15 minutes or more. Thereafter, the mixture was left to stand at room temperature (25° C.) to remove the bubbles generated during mixing, thus preparing an adhesive composition for a foldable display having a solid content of 22 wt% and a viscosity of about 1,500 cp at 25° C.

### Production of Adhesive Film for Foldable Display

A coating layer of the adhesive composition for a foldable display prepared as described above was formed on a polyester film release-treated with silicone by means of a blade coater. The coating layer was then dried using a Mathis oven at a temperature of 140° C. for 3 minutes. Thereby, an adhesive film for a foldable display including an adhesive layer having a thickness of 25 µm was produced.

### Examples 2 to 17

(Meth)acrylate-based polymers, adhesive compositions for a foldable display, and adhesive films for a foldable display were produced in the same manner as in Example 1, except that the monomer mixtures were prepared as shown in Table 1 below.

The weight-average molecular weights (Mw) of the produced (meth)acrylate-based polymers are shown in Table 1 below.

### Comparative Examples 1 to 7

(Meth)acrylate-based polymers, adhesive compositions for a foldable display, and adhesive films for a foldable display were produced in the same manner as in Example 1, except that the monomer mixtures were prepared as shown in Table 1 below.

The weight-average molecular weights (Mw) of the produced (meth)acrylate-based polymers are shown in Table 1 below.

### Comparative Example 8

### Production of (Meth)Acrylate-Based Polymer

Lauryl acrylate as a first monomer, 2-ethylhexyl acrylate as a second monomer, and acrylic acid as a polar functional group-containing (meth)acrylate-based monomer were prepared and mixed together to obtain a monomer mixture.

In this case, based on 100 parts by weight of the monomer mixture, the content of the first monomer was 20 parts by weight, the content of the second monomer was 79 parts by weight, and the content of the polar functional group-containing (meth)acrylate-based monomer was 1 part by weight.

To a 1-L reactor, in which nitrogen gas was refluxed and which was equipped with a cooling device for easy temperature control, the monomer mixture was added and then ethyl acetate (EAc) as a solvent was added. Next, the reactor was purged with nitrogen gas for about 1 hour to remove oxygen, and then the reactor temperature was maintained at 85° C. After the monomer mixture was homogenized, 5,000 ppm of benzoyl peroxide (BPO) as a reaction initiator was added thereto, and the monomer mixture was allowed to react for 3 hours, thus producing a (meth)acrylate-based polymer having a weight-average molecular weight of 500,000 g/mol. A (meth)acrylate-based polymer solution was prepared by diluting the (meth)acrylate-based polymer with ethyl acetate.

### Preparation of Adhesive Composition for Foldable Display

To the (meth)acrylate-based polymer solution prepared as described above, BXX-5240 as an epoxy-based crosslinking agent was added in an amount of 0.03 parts by weight based on 100 parts by weight of the (meth)acrylate-based polymer. The resulting mixture was diluted with methyl ethyl ketone and methyl isobutyl ketone and mixed using a mechanical stirrer for 15 minutes or more. Thereafter, the mixture was left to stand at room temperature (25° C.) to remove the bubbles generated during mixing, thus preparing an adhesive composition for a foldable display having a solid content of 22 wt% and a viscosity of about 200 cp at 25° C.

However, the weight-average molecular weight of the (meth)acrylate-based polymer prepared in Comparative Example 8 was 500,000 g/mol and the viscosity of the adhesive composition for a foldable display prepared in Comparative Example 8 was about 200 cp at 25° C. Therefore, in the process of forming a coating layer of the adhesive composition for a foldable display on a polyester film release-treated with silicone by means of a blade coater, a dewetting phenomenon occurred due to the low viscosity of the composition, making the coating impossible.

### Comparative Example 9

### Production of (Meth)Acrylate-Based Polymer

Lauryl acrylate as a first monomer, 2-ethylhexyl acrylate as a second monomer, and acrylic acid as a polar functional group-containing (meth)acrylate-based monomer were prepared and mixed together to obtain a monomer mixture.

In this case, based on 100 parts by weight of the monomer mixture, the content of the first monomer was 20 parts by weight, the content of the second monomer was 79 parts by weight, and the content of the polar functional group-containing (meth)acrylate-based monomer was 1 part by weight.

To a 1-L reactor in which nitrogen gas was refluxed, the monomer mixture was added. Then, the reactor was purged with nitrogen gas for about 1 hour to remove oxygen. Next, after the monomer mixture was homogenized, about 500 ppm of a reaction initiator (Irgacure 184) was added thereto, and the monomer mixture was then subjected to bulk polymerization under irradiation with UV light, thus producing a (meth)acrylate-based polymer having a weight-average molecular weight of 3,000,000 g/mol. A (meth)acrylate-based polymer solution was prepared by diluting the (meth)acrylate-based polymer with ethyl acetate.

### Preparation of Adhesive Composition for Foldable Display

To the (meth)acrylate-based polymer solution prepared as described above, BXX-5240 as an epoxy-based crosslinking agent was added in an amount of 0.03 parts by weight based on 100 parts by weight of the (meth)acrylate-based polymer. The resulting mixture was diluted with methyl ethyl ketone and methyl isobutyl ketone and mixed using a mechanical stirrer for 15 minutes or more. Thereafter, the mixture was left to stand at room temperature (25° C.) to remove the bubbles generated during mixing, thus preparing an adhesive composition for a foldable display having a solid content of 22 wt% and a viscosity of about 20,000 cp at 25° C.

However, the weight-average molecular weight of the (meth)acrylate-based polymer prepared in Comparative Example 9 was 3,000,000 g/mol and the viscosity of the adhesive composition for a foldable display prepared in Comparative Example 9 was about 20,000 cp at 25° C. Accordingly, in the process of forming a coating layer of the adhesive composition for a foldable display on a polyester film release-treated with silicone by means of a blade coater, the thickness non-uniformity phenomenon occurred remarkably due to the high viscosity of the composition, making the coating impossible.

TABLE 1

| | Monomer mixture | | | Mw (g/mol) | Crosslinking agent (parts by weight) |
|---|---|---|---|---|---|
| | First monomer (parts by weight) | Second monomer (parts by weight) | Monomer containing polar functional group | | |
| Example 1 | LA (20) | 2-EHA (79) | AA (1) | 1,850,000 | 0.03 |
| Example 2 | LA (25) | 2-EHA (74) | AA (1) | 1,850,000 | 0.03 |
| Example 3 | LA (35) | 2-EHA (64) | AA (1) | 1,950,000 | 0.01 |
| Example 4 | TDMA (35) | 2-EHA (63) | AA (2) | 1,650,000 | 0.01 |
| Example 5 | LA (35) | 2-EHA (63) | AA (2) | 2,000,000 | 0.03 |
| Example 6 | LA (40) | 2-EHA (59) | AA (1) | 1,900,000 | 0.01 |
| Example 7 | LA (40) | 2-EHA (58) | AA (2) | 1,950,000 | 0.01 |
| Example 8 | LA (40) | 2-EHA (58) | AA (2) | 1,950,000 | 0.03 |
| Example 9 | LA (45) | 2-EHA (53) | AA (2) | 2,000,000 | 0.01 |
| Example 10 | LA (45) | 2-EHA (53) | AA (2) | 2,000,000 | 0.03 |
| Example 11 | LA (45) | 2-EHA (52) | AA (3) | 1,950,000 | 0.03 |
| Example 12 | LA (50) | 2-EHA (48) | AA (2) | 1,850,000 | 0.03 |
| Example 13 | LA (50) | 2-EHA (47) | AA (3) | 1,850,000 | 0.03 |
| Example 14 | LA (50) | 2-EHA (46) | AA (4) | 1,950,000 | 0.03 |
| Example 15 | LA (55) | 2-EHA (43) | AA (2) | 1,950,000 | 0.03 |
| Example 16 | LA (60) | 2-EHA (38) | AA (2) | 2,000,000 | 0.03 |
| Example 17 | LA (40) | BA (58) | AA (2) | 2,100,000 | 0.03 |
| Comparative Example 1 | - | 2-EHA (98) | AA (2) | 1,950,000 | 0.03 |
| Comparative Example 2 | LA (98) | - | AA (2) | 1,850,000 | 0.03 |
| Comparative Example 3 | LA (90) | 2-EHA (8) | AA (2) | 2,000,000 | 0.03 |
| Comparative Example 4 | LA (10) | 2-EHA (88) | AA (2) | 1,900,000 | 0.03 |
| Comparative Example 5 | LA (20) | 2-EHA (79) | HBA (1) | 1,700,000 | 0.03 |
| Comparative Example 6 | LA (35) | 2-EHA (64.8) | AA (0.2) | 1,650,000 | 0.03 |
| Comparative Example 7 | LA (50) | 2-EHA (44) | AA (6) | 1,850,000 | 0.03 |
| Comparative Example 8 | LA (20) | 2-EHA (79) | AA (1) | 500,000 | 0.03 |
| Comparative Example 9 | LA (20) | 2-EHA (79) | AA (1) | 3,000,000 | 0.03 |

In Table 1 above, “LA” denotes lauryl acrylate, “TDMA” denotes tetradecyl methacrylate, “2-EHA” denotes 2-ethylhexyl acrylate, “BA” denotes butyl acrylate, “AA” denotes acrylic acid, and “HBA” denotes hydroxybutyl acrylate.

In addition, in Table 1 above, the content of each of the first monomer, the second monomer and the polar functional group-containing monomer is based on 100 parts by weight of the monomer mixture, and the content of the crosslinking agent is based on 100 parts by weight of the (meth)acrylate-based polymer.

### Experimental Example

### Measurement of Storage Modulus

The storage moduli of the adhesive layers, produced in Examples 1 to 17 and Comparative Examples 1 to 4, at -20° C. and 25° C., were measured using an Advanced Rheometric Expansion System G2 rheometer (TA Instruments) as follows.

Specifically, a sample was prepared by laminating the adhesive layer, produced in Example 1, to a thickness of 1 mm. Then, using a parallel plate fixture having a diameter of 8 mm, the storage modulus of the sample at each of -20° C. and 25° C. was measured.

### <Measurement Conditions>

Strain: 5%
Frequency: 1 Hz
Initial temperature: -40° C.; final temperature: 90° C.
Heating temperature: 10° C./min

In addition, the storage moduli of the adhesive layers, produced in Examples 2 to 17 and Comparative Examples 1 to 4, at -20° C. and 25° C., were measured in the same manner as described above, and the results of the measurement are shown in Table 2 below.

### Folding Evaluation

The folding evaluation of each of the adhesive layers produced in Examples 1 to 17 and Comparative Examples 1 to 7 was performed as follows.

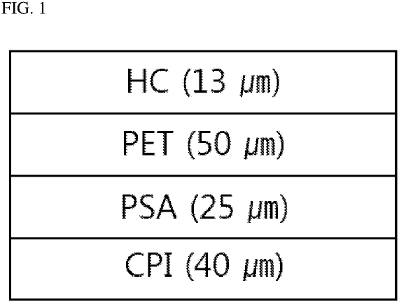

FIG. 1 is a schematic view showing a sample for folding evaluation.

As shown in FIG. 1, using the adhesive layer (PSA) produced in each of Examples 1 to 17 and Comparative Examples 1 to 7, colorless polyimide (CPI) having a thickness of 40 µm was bonded to a cover window (LG Chem Ltd.) including a 13-µm-thick hard coating formed on one surface of a 50-µm-thick PET, thus producing a laminate.

Thereafter, a sample was prepared by cutting a laminate having a laminate structure of cover window (HC/PET)/adhesive layer (PSA)/CPI to a size of 140 mm × 80 mm.

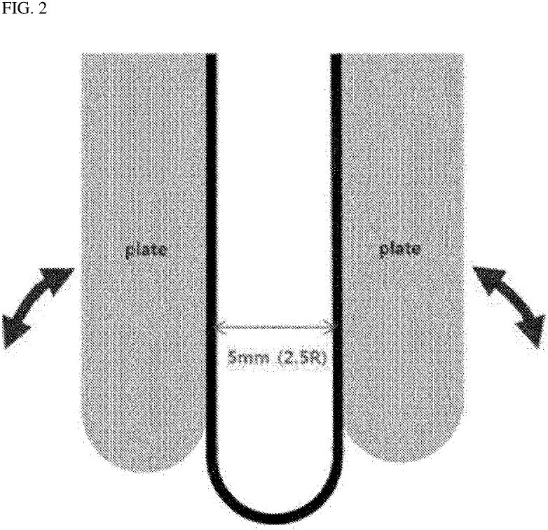

FIG. 2 is a schematic view showing a folding test.

As shown in FIG. 2, under a temperature condition of -20° C., the sample was sandwiched between parallel plates of the folding test device, and folded once per second with a curvature radius of 5 mm. In this manner, a dynamic folding test consisting of a total of 200,000 folding cycles was performed.

After the test was completed, the sample was collected, and bubble generation, lifting, and cracking of the hard coating layer were observed visually. If there were no bubble generation and lifting and no cracking of the hard coating layer, the sample was evaluated as “OK”, and if there was bubble generation or lifting, or cracking of the hard coating layer, the sample was evaluated as “NG”. The results of the evaluation are shown in Table 2 below.

TABLE 2

| | Storage modulus (-20° C., Pa) | Storage modulus (25° C., Pa) | Folding evaluation (-20° C., 200,000 cycles) |
|---|---|---|---|
| Example 1 | 91,000 | 28,000 | OK |
| Example 2 | 74,000 | 25,000 | OK |
| Example 3 | 59,000 | 22,000 | OK |
| Example 4 | 92,000 | 27,000 | OK |
| Example 5 | 81,000 | 25,000 | OK |
| Example 6 | 48,000 | 17,000 | OK |
| Example 7 | 89,000 | 24,000 | OK |
| Example 8 | 89,000 | 25,000 | OK |
| Example 9 | 61,000 | 20,000 | OK |
| Example 10 | 61,000 | 22,000 | OK |
| Example 11 | 92,000 | 32,000 | OK |
| Example 12 | 43,000 | 20,000 | OK |
| Example 13 | 71,000 | 25,000 | OK |
| Example 14 | 93,000 | 31,000 | OK |
| Example 15 | 75,000 | 23,000 | OK |
| Example 16 | 98,000 | 23,000 | OK |
| Example 17 | 83,000 | 36,000 | OK |
| Comparative Example 1 | 190,000 | 43,000 | NG |
| Comparative Example 2 | 210,000 | 56,000 | NG |
| Comparative Example 3 | 148,000 | 37,000 | NG |
| Comparative | 134,000 | 44,000 | NG |
| Example 4 | | | |
| Comparative Example 5 | 87,000 | 27,000 | NG (lifting) |
| Comparative Example 6 | 56,000 | 18,000 | NG (lifting) |
| Comparative Example 7 | 190,000 | 48,000 | NG (cracking of hard coating) |

Referring to Tables 1 and 2 above, it was confirmed that the adhesive layers produced in Examples 1 to 17 of the present invention all satisfied a storage modulus of 100,000 Pa or lower as measured at -20° C., suggesting that the results of folding evaluation at -20° C. for the samples were excellent. In addition, it was confirmed that the adhesive layers produced in Examples 1 to 17 all had a storage modulus of 10,000 Pa or higher as measured at 25° C.

On the other hand, it was confirmed that the adhesive layer of Comparative Example 1, produced without using the first monomer LA, and the adhesive layer of Comparative Example 2, produced without using the second monomer 2-EHA, both had a storage modulus higher than 100,000 Pa as measured at -20° C., suggesting that the results of folding evaluation performed at -20° C. were poor.

In addition, it was confirmed that, in the case of the adhesive layers produced in Comparative Examples 3 and 4 in which the contents of the first monomer and the second monomer did not satisfy the content ranges according to the embodiment of the present invention, the storage modulus was higher than 100,000 Pa as measured at -20° C., suggesting that the results of folding evaluation performed at -20° C. were poor.

Meanwhile, it was confirmed that, in the case of Comparative Example 5 in which the (meth)acrylate-based monomer containing a hydroxyl group was used as the (meth)acrylate-based monomer containing a polar functional group, the storage moduli at -20° C. and 25° C. were appropriate, but the results of folding evaluation performed at -20° C. were poor.

In addition, it was confirmed that, in the case of Comparative Examples 6 and 7 in which the content of the (meth)acrylate-based monomer containing a polar functional group was excessively high or low, the results of folding evaluation performed at -20° C. were poor.

Therefore, it can be seen that the adhesive composition for a foldable display according to one embodiment of the present invention may provide an adhesive layer having excellent folding properties even under low temperature conditions such as -20° C.

What is claimed is:

1. An adhesive composition for a foldable display containing a (meth)acrylate-based polymer which is a reaction product of a monomer mixture containing:
a first monomer comprising at least one of a first acrylate-based monomer containing an alkyl group having 12 to 14 carbon atoms, and a first methacrylate-based monomer containing an alkyl group having 14 to 16 carbon atoms;
a second monomer comprising at least one of a second acrylate-based monomer containing an alkyl group having 3 to 10 carbon atoms, and a second methacrylate-based monomer containing an alkyl group having 8 to 12 carbon atoms; and
a (meth)acrylate-based monomer containing a polar functional group.

2. The adhesive composition of claim 1, wherein the first monomer is contained in an amount of 20 parts by weight to 60 parts by weight based on 100 parts by weight of the monomer mixture.

3. The adhesive composition of claim 1, wherein the second monomer is contained in an amount of 35 parts by weight to 80 parts by weight based on 100 parts by weight of the monomer mixture.

4. The adhesive composition of claim 1, wherein the (meth)acrylate-based monomer containing the polar functional group is contained in an amount of 1 part by weight to 4 parts by weight based on 100 parts by weight of the monomer mixture.

5. The adhesive composition of claim 1, wherein a weight ratio between the first monomer and the (meth)acrylate-based monomer containing the polar functional group is 1:0.025 to 1:0.1.

6. The adhesive composition of claim 1, wherein a weight ratio between the first monomer and the second monomer is 1:0.5 to 1:4.

7. The adhesive composition of claim 1, wherein a weight ratio between the (meth)acrylate-based monomer containing the polar functional group and the second monomer is 1:10 to 1:85.

8. The adhesive composition of claim 1, wherein the (meth)acrylate-based monomer containing the polar functional group contains a carboxylic acid group.

9. The adhesive composition of claim 1, further containing an epoxy-based crosslinking agent.

10. The adhesive composition of claim 9, wherein the epoxy-based crosslinking agent is contained in an amount of 0.01 parts by weight to 0.1 parts by weight based on 100 parts by weight of the (meth)acrylate-based polymer.

11. The adhesive composition of claim 1, wherein the (meth) acrylate-based polymer has a weight-average molecular weight of 1,500,000 to 2,500,000 g/mol.

12. An adhesive film for a foldable display comprising an adhesive layer comprising a cured product of the adhesive composition for a foldable display according to claim 1.

13. The adhesive film of claim 12, wherein the adhesive layer has a storage modulus of 100,000 Pa or lower as measured at -20° C.

14. The adhesive film of claim 12, wherein the adhesive layer has a storage modulus of 10,000 Pa or higher as measured at 25° C.
